(19) United States
(12) Patent Application Publication
(10) Pub. No.: US 2022/0260458 A1
(43) Pub. Date: Aug. 18, 2022

(54) Vehicle Inspection System

(71) Applicant: Zahid F. Mian, Loudonville, NY (US)

(72) Inventor: Zahid F. Mian, Loudonville, NY (US)

(21) Appl. No.: 17/672,883

(22) Filed: Feb. 16, 2022

Related U.S. Application Data
(60) Provisional application No. 63/150,300, filed on Feb. 17, 2021.

(51) Int. Cl. G01M 17/013; G01N 21/95; G06T 7/73; G01M 17/02; G01N 21/88

(52) U.S. Cl. CPC G01M 17/013; G01N 21/95; G06T 7/73; G06T 2207/20081; G01N 21/8851; G06T 2207/30252; G01M 17/02

(57) ABSTRACT

A vehicle inspection system to inspect one or more components of a vehicle moving on a path includes at least one vision sensor configured to capture one or more images of the vehicle, and at least one acoustic sensor configured to capture an acoustic data generated during the motion of the vehicle. The vehicle inspection system also includes a controller in communication with the at least one vision sensor and the at least one acoustic sensor and receives one or more images and receives the acoustic data from the at least one acoustic sensor. The controller is configured to determine one or more defects associated with one or more components of the vehicle based on at least one of the one or more images received or the acoustic data.

### CROSS-REFERENCE TO RELATED APPLICATIONS

This application claims priority to and the benefit of U.S. Provisional Patent Application No. 63/150300, filed on Feb. 17, 2021, the contents of which are hereby incorporated by reference herein for all purposes.

### TECHNICAL FIELD

The present disclosure pertains to a vehicle inspection system. More particularly, the present disclosure pertains to a vehicle inspection system mounted along a travel path to determine one or more defects of one or more components of a vehicle during a movement of the vehicle.

### BACKGROUND

Effective detection of one or more flaws in vehicles, such as commercial vehicle travelling on a rod is highly desirable. For example, detection of flaws or problems with the wheels, tires of the wheels, brake components, transmission, engine, etc., is desirable so that corrective action(s) can be taken. Exiting inspection systems that attempt to detect brake/wheel components defects are generally thermal imaging based systems and have a high rate of false positives, which is undesirable.

### SUMMARY

According to an aspect of the disclosure, a vehicle inspection system to inspect one or more components of a vehicle moving on a path is disclosed. The vehicle inspection system includes at least one vision sensor configured to capture one or more images of the vehicle moving on the path, and at least one acoustic sensor configured to capture an acoustic data generated during the motion of the vehicle. The vehicle inspection system also includes a controller in communication with the at least one vision sensor and the at least one acoustic sensor and is configured to receive one or more images captured by the at least one vision sensor, and receive the acoustic data from the at least one acoustic sensor. The controller is configured to determine one or more defects associated with one or more components of the vehicle based on at least one of the one or more images received from the at least one vision sensor, or the acoustic data received from the at least one acoustic sensor.

In some embodiments, the at least one vision sensor includes two vision sensors, and each vision sensor is stereo imaging camera.

In some embodiments, the acoustic sensor is a microphone.

In some embodiments, the controller includes a first machine learning model to analyze the one or more images received from the at least one vision sensor to determine the one or more defects of the one or more components of the vehicle.

In some embodiments, the controller is configured to inspect a wheel of the vehicle based on the one or more images.

In some embodiments, the controller is configured to determine a tire surface condition and a tread depth of a tire of the wheel based on the one or more images.

In some embodiments, the controller includes a second machine learning model to analyze the acoustic data received from the at least one acoustic sensor to determine the one or more defects of the one or more components of the vehicle.

In some embodiments, the second machine learning mode is configured to identify a periodic tire noise from the acoustic data and determine a tire defect based on the periodic tire noise.

In some embodiments, the controller is configured to identify a type of the vehicle based on the one or more images received from the at least one vision sensor.

In some embodiments, the controller is configured to correlate the one or more images received from the at least one vision sensor and the acoustic data received from the at least one acoustic sensor to determine the one or more defects of the one or more components of the vehicle.

According to an aspect of the disclosure, a method for inspecting one or more components of a vehicle moving on a path is disclosed. The method includes receiving, by a controller, one or more images captured by at least one vision sensor arranged along the path of the movement of the vehicle, and receiving, by the controller, an acoustic data captured by at least one acoustic sensor arranged along the path of the movement of the vehicle. The method further includes determining, by the controller, one or more defects associated with one or more components of the vehicle based on at least one of the one or more images received from the at least one vision sensor, or the acoustic data received from the at least one acoustic sensor.

In some embodiments, determining the one or more defects of the one or more components of the vehicle includes analyzing the one or more images received from the at least one vision sensor by using a first machine learning model.

In some embodiments, the controller inspects a wheel of the vehicle based on the one or more images.

In some embodiments, the controller determines a tire surface condition and a tread depth of a tire of the wheel based on the one or more images.

In some embodiments, determining the one or more defects of the one or more components of the vehicle includes analyzing the acoustic data received from the at least one acoustic sensor by using a second machine learning model.

In some embodiments, the second machine learning model identifies a periodic tire noise from the acoustic data, and determines a tire defect based on the periodic tire noise.

In some embodiments, the method further includes identifying, by the controller, a type of the vehicle based on the one or more images received from the at least one vision sensor.

In some embodiments, determining the one or more defects of the one or more components of the vehicle includes correlating the one or more images received from the at least one vision sensor and the acoustic data received from the at least one acoustic sensor.

### BRIEF DESCRIPTION OF THE DRAWINGS

FIG. 1 illustrates a schematic view of a vehicle inspection system having two sensing units, in accordance with an embodiment of the disclosure; and

FIG. 2 illustrates two sensing units of FIG. 1 arranged on two opposing sides of a travel path of a vehicle, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances there between, are not necessarily to scale, and may be disproportionate and/or exaggerated for clarity.

The terminology used herein is for the purpose of describing example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges there between. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” “left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

For the purposes of the present disclosure, at least one of A, B, or C includes, for example, A only, B only, or C only, as well as A and B, A and C, B and C; or A, B, and C, or any other all combinations of A, B, and C.

For the purposes of the present disclosure, one of A or B includes, for example, A only, B only.

For the purposes of the present disclosure, one of A and B includes, for example, A only, B only.

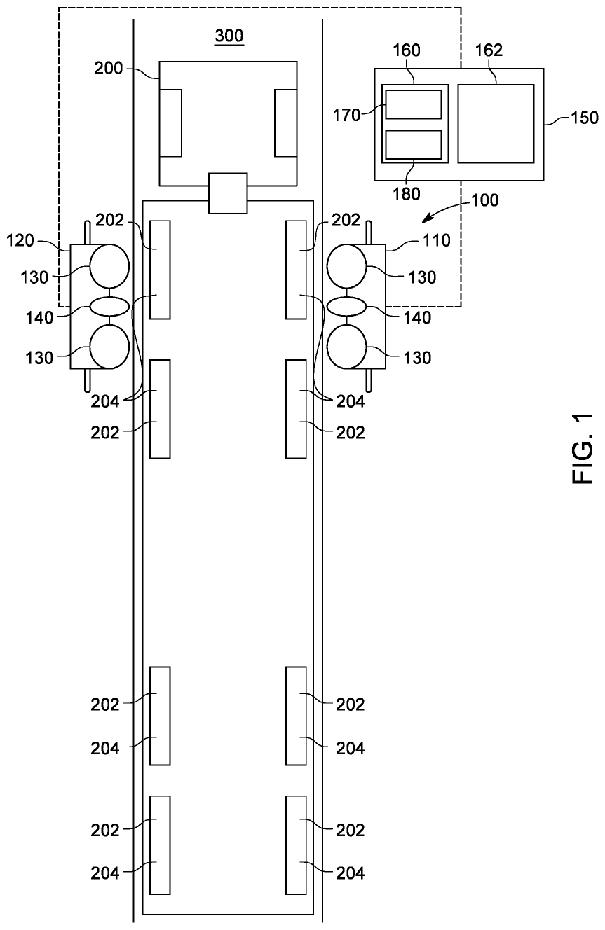

Referring to FIG. 1, a schematic view of a vehicle inspection system 100 (hereinafter simply referred to as system 100) configured to inspect or monitor one or more components of a vehicle 200 moving on the road or a path 300 is shown. The system is configured to determine a failure or a defect of the one or more components 202 of the vehicle 200. In an embodiment, the one or more components 202 includes wheels 204 of the vehicle 200. In some embodiment, the system 100 is also configured to determine a defect in an engine, a gear box, or transmission, a propeller shaft, a fuel tank, etc., of the vehicle 200. In some embodiments, the system 100 is also configured to determine and engine oil leakage, a transmission oil leakage etc.

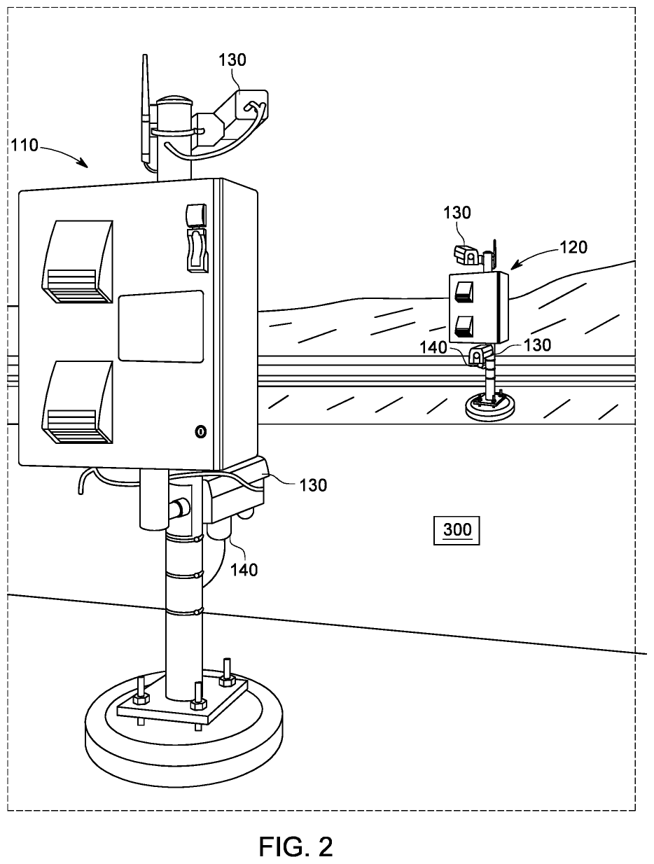

Referring to FIGS. 1 and 2, the system 100 includes at least one sensing unit, for example, a first sensing unit 110 arranged on a first side of the path 300, and a second sensing unit 120 arranged on a second side of the path 300, the second side being opposite to the first side of the road or path 300 to capture data associated with the right side and left side of the vehicle 100 to inspect the components arranged on both sides of the vehicle 200. The first sensing unit 110 is identical to the second sensing unit 120, and therefore, only first sensing unit 110 is explained in detail.

As shown in FIG. 2, the first sensing unit 110 (hereinafter referred to as sensing unit 110) includes at least one vision sensor, for example, two vision sensors 130, to acquire a plurality of images of the vehicle 200. In an embodiment, the vision sensors 130 are arranged to capture one or more images of the wheels 304 of the vehicle 200 and an underside of the vehicle 200. However, it may be appreciated that the vision sensors 130 may be mounted and arranged to capture images of the entire vehicle 200 or a portion of the vehicle 200. Also, the vision sensors 130 are arranged to a capture a registration number of the vehicle 200 that may be displayed at a front and/or a rear of the vehicle 200. In an embodiment, the vision sensor 130 may be an image capturing device, for example, a video camera. In some embodiments, the vision sensor 130 may be a stereo imaging camera to capture a depth in the image data.

Additionally, the sensing unit 110 includes at least one acoustic sensor 140 adapted to a capture of the acoustic data generated during travel of the vehicle 100. In an embodiment, the acoustic sensor 140 may be a microphone that collects capture the acoustic data of the vehicle 500 while the vehicle is passing in the vicinity of the sensing unit 110.

Further, the system 100 includes a controller 150 arranged in communication with the sensing unit 110, and receives the image data and acoustic data from by the vision sensors 130 and the acoustic sensor 140. The controller 150 is configured to determine a defect in one or more components 202 of the vehicle 300 based on image data and/or the acoustic data. Further, the controller 150 is configured to identify the vehicle 200 from the image data received from the vision sensors 130 and associates the image data and the acoustic data with the identified vehicle 200. In an embodiment, the controller 150 is configured to determine a registration number of the vehicle 200 from the image data and determine an information related to the vehicle 200 based on the registration number. For so doing, the controller 150 may be in communication with a central vehicle information database (not shown), and may identify the type of vehicle 200, an owner of the vehicle 200 from the central vehicle information database via the registration number. In some embodiments, the controller 150 may identify a type of the vehicle based on the images received from the vision sensors 130. The type of vehicle may include a truck, a trailer, a bus, or any other vehicle.

To facilitate a data exchange between the sensing units 110, 120 and the controller 150, the system 100 includes a communication device, for example, a transceiver. In an embodiment, the communication device may transmit and/or receive a plurality of analog signals or a plurality of digital signals for facilitating the wireless communication of the communication device with the controller 150 and transmit data received from the sensing units 110, 120 to the controller 150. In an embodiment, the controller 150 may be onboard an assembly housing the sensing unit 110, 120. Alternatively, the controller 150 may be a remote controller disposed remotely from the sensing unit 110.

The controller 150 may include a processor 160 for executing specified instructions, which controls and monitors various functions associated with the system 100. The processor 160 may be operatively connected to a memory 162 for storing instructions related to the functioning of the system 100 and components of the system 100. In an embodiment, the memory 162 may also store various events performed during the operations of the system 100.

The memory 162 as illustrated is integrated into the controller 150, but those skilled in the art will understand that the memory 162 may be separate from the controller 150 or remote from the controller 150, while still being associated with and accessible by the controller 150 to store information in and retrieve information from the memory 162 as necessary during the operation of the system 100. Although the processor 160 is defined, it is also possible and contemplated to use other electronic components such as a microcontroller, an application specific integrated circuit (ASIC) chip, or any other integrated circuit device may be used for preforming the similar function. Moreover, the controller 150 may refer collectively to multiple control and processing devices across which the functionality of the system 100 may be distributed. For example, the vision sensors 130 and the acoustic sensor 140, may each have one or more controllers that communicate with the controller 150.

In an embodiment, the controller 150 may include a first trained machine learning model 170 (shown in FIG. 1) adapted to identify one or more components 202 of the is vehicle 200 from the image data received from the vision sensors 130, and is configured to identify one or more attributes of each components 202 from the image data. In an embodiment, the images received from the vision sensors 130 are preprocessed to account of lighting, shadows, exposure, etc., before performing the analysis of the images. In an embodiment, the one or more attributes includes a shape, one or more dimensions, a size, any deformity, etc., of the one or more components 202 of the vehicle 200. The first machine learning model 170 is also trained to ascertain whether the one or more attributes relates to a normal operating condition of each of the components 202. The first machine learning model 170 may be trained based on the images acquired from a long normal operation/running of the similar vehicles. In an embodiment, the first machine learning model 170 may be a convolutional neural network-based model, a random forest-based model, a support vector machines-based model, a k-nearest neighbors algorithm based model, a symbolic regression based model, a model based on supervised machine learning algorithm or any other such model known in the art or a combination thereof to analyze the image data to identify/determine the one or more defects of the one or more components 202 of the vehicle 200.

The first machine learning model 170 facilitates a detection of any deviation from the standard condition or functioning of the one or more components 202 of the vehicle 200, and identify/determine one or more defects in the one or more components 202 accordingly. In an embodiment, the training data is stored in a training database to be accessed by the processor 160 (i.e., the first machine learning model 170). For example, the processor 160 by using the first machine learning model 170 identifies a tire surface degradation, for example, cracks, bulging, exposed ply, sidewall piercing, etc., of the tire and a tread depth of the tire and determines if a tread depth is below a minimum value. The processor 160 by using the first machine learning model 170 may also identify/determine if one or more bolt is missing from a rim of a wheel 204 of the vehicle 200 by analyzing the images received from the vision sensors 130. Similarly, the processor 160 may also identifies whether there is wobble in any of the tire or the wheel 204 is loosely attached to axle by analyzing sequential images received from the vision sensors 130. In some embodiments, the processor 160 may also identify/determine a leakage of fluid from the brakes of the vehicle 200 by identifying any lubricant dripping near the wheels 204 based on the images received from the vision sensors 130. In an embodiment, the processor 160 by using the first machine learning model 170 is adapted to identify/determine any dangling component underneath the vehicle 200 based on analyzing a sequence of images received from the vision sensors 130. In an embodiment, the processor 160 with the help of the first machine learning model 170 may perform a smoke detection analysis on the plurality of images captured from the vision seniors 130 using a gray and transparency feature to facilitate the detection of the one or more leaking components of the vehicle 200. The processor 160 is configured to associate the identified one or more defects with the one or more components 202 and the vehicle 200, and stores the data in the memory 162.

In an embodiment, the controller 150 may include a second trained machine learning model 180 (shown in FIG. 1) adapted to identify/determine one or more defects of the one or more components 202 from the acoustic data received from the at least one acoustic sensor 140. The second machine learning model 180 is trained to differentiate between various acoustic waves received from the acoustic sensor 140, and to identify a pitch, a frequency, a modulation, a wavelength, or any other attributes related to each acoustic wave. The second machine learning model 180 may be trained based on the acoustics acquired from a long normal operation/running of the similar vehicles and the components 202. In an embodiment, the second machine learning model 180 may be a convolutional neural network-based model, a random forest-based model, a support vector machines-based model, a k-nearest neighbors algorithm based model, a symbolic regression based model, a model based on supervised machine learning algorithm, fast Fourier transform, or any other such model known in the art, or a combination thereof to analyze the acoustic data to identify/determine the one or more defects of the one or more components 202 of the vehicle 200.

The second machine learning model 180 facilitates a detection of any deviation of the acoustic data received from the acoustic sensor 140 from the standard acoustics generated during a normal functioning of the one or more components 202 of the vehicle 200, and identifies/determines one or more defects in the one or more components 202 accordingly. In an embodiment, the training data is stored in a training database to be accessed by the processor 160 (i.e., second machine learning model 180). For example, the processor 160 by using the second machine learning model 180 that may be based on a Fourier transform may identify/decipher a periodic tire noise to determine that a tire of a wheel 204 is defective. Additionally, the processor 160 by using the second machine learning model 180 may identify or decipher engine noise issues, and other running gear noise issues by analyzing sound amplitude as well as noise spectral content of the acoustic data to determine/identify defects in engine, transmission, etc. The processor 160 is configured to associate the identified one or more defects with the component 202 and/or the vehicle 200, and stores the data in the memory 162.

Additionally, the processor 160 is configured to correlate the image data and the acoustic data and the analysis of the image data and the analysis of the acoustic data to identify/determine the one or more defects in one or more components 202. For example, the processor 160 may correlate the periodic tire sound with a defect detected in the image data and determines a defective tire of a wheel 204 accordingly. In an embodiment, the processor 160 may correlate the engine sound with a leakage of the engine oil to determine a defect in the engine. In an embodiment, the processor 160 may correlate an abnormal sound from the brake with the image data to identify/determine a wear and tear in a brake liner and/or leakage of brake fluid. In this manner, the vehicle inspection system 100 facilitates an identification of one more defects and potential failure of the one or more components 202 of the vehicle 200 as the vehicle crosses the sensing units 110, 120 mounted along the roads. The controller 150 is configured to transmit the data related to one or more components of the vehicle 200 to a central system, which may transmit the information to an owner of the vehicle 200 and/or a driver of the vehicle 200.

A method for inspecting the one or more components 202 of the vehicle 200 is now described. The method includes capturing one or more images of the vehicle 200, by the vision sensors 130, as the vehicle 200 passes the sensing unit 110 during the movement of the vehicle 200 along the path 300. The method also includes capturing the acoustic data associated with the vehicle 200, by the acoustic sensor 140, as the vehicle 200 passes the sensing unit 110 during the movement of the vehicle 200 along the path 300. The captured one or more images and the acoustic data is transmitted to the controller 150. Accordingly, the controller receives the one or more images and the acoustic data from the at least one vision sensor 130 and the acoustic sensor 140, respectively. Thereafter, the processor 160 by using the first machine learning model 170 identifies/determines one or more detects associated with the one or more components 202 of the vehicle 200 by analyzing the one or more images. Also, the processor 160 by using the second machine learning model 170 identifies/determines one or more detects associated with the one or more components 202 of the vehicle 200 by analyzing the acoustic data.

In an embodiment, the processor 160 may correlate the one or more images and the acoustic data to identify/determine the one or more defects associated with one or more components 202 of the vehicle. In some embodiments, the processor 160 may identify an information, for example, a type of vehicle, details of an owner or a driver of the vehicle 200 based on the one or more images. In an embodiment, the processor 160 may identify a registration number of the vehicle 200 from the one or more images and accordingly determine the vehicle information.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended specification.

What is claimed is:

1. A vehicle inspection system to inspect one or more components of a vehicle moving on a path, the vehicle inspection system comprising:
at least one vision sensor configured to capture one or more images of the vehicle moving on the path;
at least one acoustic sensor configured to capture an acoustic data generated during the motion of the vehicle; and
a controller in communication with the at least one vision sensor and the at least one acoustic sensor and configured to
receive one or more images captured by the at least one vision sensor,
receive the acoustic data from the at least one acoustic sensor,
determine one or more defects associated with one or more components of the vehicle based on at least one of
the one or more images received from the at least one vision sensor, or
the acoustic data received from the at least one acoustic sensor.

2. The vehicle inspection system of claim 1, wherein the at least one vision sensor includes two vision sensors, and each vision sensor is a stereo imaging camera.

3. The vehicle inspection system of claim 1, wherein the acoustic sensor is a microphone.

4. The vehicle inspection system of claim 1, wherein the controller includes a first machine learning model to analyze the one or more images received from the at least one vision sensor to determine the one or more defects of the one or more components of the vehicle.

5. The vehicle inspection system of claim 1, wherein the controller is configured to inspect a wheel of the vehicle based on the one or more images.

6. The vehicle inspection system of claim 5, wherein the controller is configured to determine a tire surface condition and a tread depth of a tire of the wheel based on the one or more images.

7. The vehicle inspection system of claim 1, the controller includes a second machine learning model to analyze the acoustic data received from the at least one acoustic sensor to determine the one or more defects of the one or more components of the vehicle.

8. The vehicle inspection system of claim 7, wherein the second machine learning mode is configured to identify a periodic tire noise from the acoustic data and determine a tire defect based on the periodic tire noise.

9. The vehicle inspection system of claim 1, wherein the controller is configured to identify a type of the vehicle based on the one or more images received from the at least one vision sensor.

10. The vehicle inspection system of claim 1, wherein the controller is configured to correlate the one or more images received from the at least one vision sensor and the acoustic data received from the at least one acoustic sensor to determine the one or more defects of the one or more components of the vehicle.

11. A method for inspecting one or more components of a vehicle moving on a path, the method comprising:
receiving, by a controller, one or more images captured by at least one vision sensor arranged along the path of the movement of the vehicle;
receiving, by the controller, an acoustic data captured by at least one acoustic sensor arranged along the path of the movement of the vehicle; and
determining, by the controller, one or more defects associated with one or more components of the vehicle based on at least one of
the one or more images received from the at least one vision sensor, or
the acoustic data received from the at least one acoustic sensor.

12. The method of claim 11, wherein determining the one or more defects of the one or more components of the vehicle includes analyzing the one or more images received from the at least one vision sensor by using a first machine learning model.

13. The method of claim 11, wherein the controller inspects a wheel of the vehicle based on the one or more images.

14. The method claim 13, wherein the controller determines a tire surface condition and a tread depth of a tire of the wheel based on the one or more images.

15. The vehicle inspection system of claim 11, wherein determining the one or more defects of the one or more components of the vehicle includes analyzing the acoustic data received from the at least one acoustic sensor by using a second machine learning model.

16. The method of claim 15, wherein the second machine learning model identifies a periodic tire noise from the acoustic data and determines a tire defect based on the periodic tire noise.

17. The method of claim 11 further including identifying, by the controller, a type of the vehicle based on the one or more images received from the at least one vision sensor.

18. The method of claim 11, wherein determining the one or more defects of the one or more components of the vehicle includes correlating the one or more images received from the at least one vision sensor and the acoustic data received from the at least one acoustic sensor.
